(19) United States
(12) Patent Application Publication
(10) Pub. No.: US 2015/0099245 A1
(43) Pub. Date: Apr. 9, 2015

(54) METHOD FOR MONITORING AN ACTIVITY OF A COGNITIVELY IMPAIRED USER AND DEVICE THEREFORE

(71) Applicant: UNIVERSITE DU QUEBEC A CHICOUTIMI, Chicoutimi (CA)

(72) Inventors: Bruno Bouchard, Chicoutimi (CA); Kevin Bouchard, Chicoutimi (CA); Abdenour Bouzouane, Quebec (CA); Dany Bouchard, St-Michel (CA)

(21) Appl. No.: 14/502,125

(22) Filed: Sep. 30, 2014

Related U.S. Application Data
(60) Provisional application No. 61/885,191, filed on Oct. 1, 2013.

(51) Int. Cl. G09B 5/00; G06F 3/01

(52) U.S. Cl. CPC G09B 5/00; G06F 3/015
USPC 434/127

(57) ABSTRACT

The method for monitoring an activity of a cognitively impaired user using a device having a body resting on a plurality of support areas and loadable by the cognitively impaired user, generally comprises the step of measuring a plurality of force values exerted by a weight of a load to corresponding ones of the support areas; the step of obtaining a state of an activity of the cognitively impaired user based on the measured values; and the step of generating a signal indicative of the state of the activity. The state of the activity typically can be a given step in a recipe to be cooked on a smart stove in order to assist a cognitively impaired person in the completion of a cooking activity.

### REFERENCE TO RELATED APPLICATIONS

This patent application claims priority of U.S. provisional Application Ser. No. 61/885,191, filed on Oct. 1, 2013, the contents of which are hereby incorporated by reference.

### BACKGROUND

Cognitively impaired persons such as elderly people and people having intellectual disabilities and/or a loss of autonomy generally have to routinely perform tasks using devices designed for healthy people, which do not take into consideration their cognitive impairment. One approach was to provide automated systems which perform tasks or activities in their place. However, clinical studies have shown that encouraging users to maintain a certain level of autonomy helped to preserve health, and in this sense, automated systems had the inconvenience of entirely removing the autonomy of the user. There thus remained room for improvement. Moreover, there also remained room for solutions which allow to track an activity of a cognitively impaired user.

### SUMMARY

In accordance with one aspect, there is provided an intelligent appliance which assists the user to accomplish a task or an activity while allowing the user to maintain the autonomy of performing steps of the activity which he/she is not prevented to accomplish by his/her cognitive impairment. Henceforth, the intelligent appliance can palliate the cognitive impairment of the user by sequentially providing steps of an activity such as cooking a recipe. Additionally, the intelligent appliance can monitor his/her security and advise the user in the event of a forgotten step, while allowing the user to maintain a satisfactory degree of autonomy.

For instance, a smart stove having sensors for tracking an activity of the user can be paired with a computer which has a user interface and a memory for storing recipes. The computer can track the completion of steps of the recipe, or the failure of a step, using input from the sensors. By processing the signal from dispersed force sensors, one can determine a load distribution that is indicative of what part of the smart stove is loaded with a particular weight, the latter generally being a food or a vessel containing food. Typically, the usual kitchen stove has a cooktop having four or more heating areas provide in the form of burners or elements thereon and an oven having typically two heating areas such as grids therein. Based on the determined load distribution, and at least in certain controlled circumstances, the smart stove can determine which one of the heating areas is loaded with the food, and further assist the user with the completion of the recipe, for instance.

In accordance with another aspect, there is provided an intelligent furniture which monitors a state of an activity of the user resting thereon. Particularly, the furniture can be a smart chair or a smart bed having sensors for determining a load distribution indicative of an activity of the cognitively impaired user. Moreover, the smart furniture can track an activity, such as a night of sleep or a day of work, based on the load distribution and store the information in a memory, where it can later be used to determine if the device was used ergonomically and/or securely by the cognitively impaired person, for instance.

In accordance with one aspect, there is provided a method for monitoring an activity of a cognitively impaired user using a device having a body resting on a plurality of support areas and loadable by the cognitively impaired user, the method comprising: measuring a plurality of force values exerted by a weight of a load to corresponding ones of the support areas; obtaining a state of an activity of the cognitively impaired user based on the measured values; and generating a signal indicative of the state of the activity.

In accordance with another aspect, there is provided a device for monitoring an activity of a cognitively impaired user, the device comprising: a body resting on a plurality of support areas and loadable by the cognitively impaired user; and at least three force sensors adapted to measure force values applied by the loaded body to corresponding ones of the plurality of support areas, each force sensor being horizontally spaced from a center of gravity of the device and horizontally spaced from one another.

There is provided herein devices which can be operatively connected to the existing Internet infrastructure and/or to other devices connected thereto. Indeed, it is contemplated that such a connectivity is to be referred to as the Internet-of-Things (IoT) and can offer advanced functions that goes beyond mere machine-to-machine communications (M2M).

Many further features and combinations thereof concerning the present improvements will appear to those skilled in the art following a reading of the instant disclosure.

### DESCRIPTION OF THE FIGURES

In the figures,

FIG. 1 is an oblique view of an example of a cooking appliance for monitoring an activity of a cognitively impaired user having four force sensors at corresponding four support areas;

FIG. 2 is a top view of the device of FIG. 1 showing the four force sensors spread around a center of gravity of the device;

FIG. 3 is an example of an interface of the user mode of the cooking device;

FIG. 4 is an example showing an interface of the free use mode;

FIG. 5 is an example showing an interface of the recipe-monitoring mode; and

FIG. 6 is an example of a flow chart showing the algorithm of the recipe-monitoring mode of the device.

### DETAILED DESCRIPTION

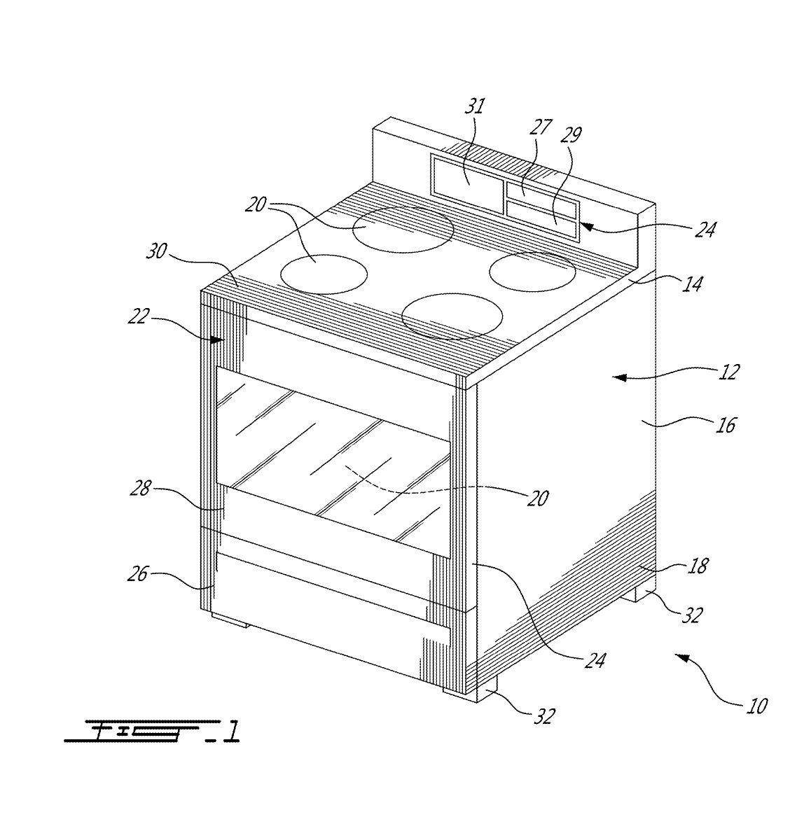

In one embodiment, the device is a cooking appliance 10 such as a kitchen stove, as shown in FIG. 1. Typically, the cooking appliance 10 has a body 12 that has an upper portion 14, a middle portion 16 and a lower portion 18, wherein the upper portion 14 has four heating areas 20 made integral thereon, and the middle portion 16 can have an oven 22 embedded therein. The oven 22 has a door 24 making it easy for the user to place a weight of product or a product container containing the weight of product on one of the cooking grids therein, the latter also considered as being heating areas 20 in it. It is readily understood that the product can be food and the product container can be a food container such as a plate or a vessel. Indeed, the upper portion 15 of the body 12 can be referred to as a cooktop 30 having burners or elements or heating areas. Each heating area 20 can be controlled via a computer 24 to generate a desired level of heat to the chosen heating area. The heat generated can be transferable to a food directly placed on one of the grids of the oven or to a food container containing food on one of the heating area of the cooktop 30. The device also has a drawer 26 made integral to the lower portion 18. The drawer 26 and the door 24 of the oven 22 are aligned on a front face 28 of the body 12, where the heating areas 20 are positioned on the cooktop 30 integral to the body 12. Generally, the computer 24 controls the desired level of heat to be generated by the heating areas 20 of the cooktop 30 and of the oven 22. The computer 24 is generally incorporated in the upper portion 14 of the body 12, for easy and secure access for the user.

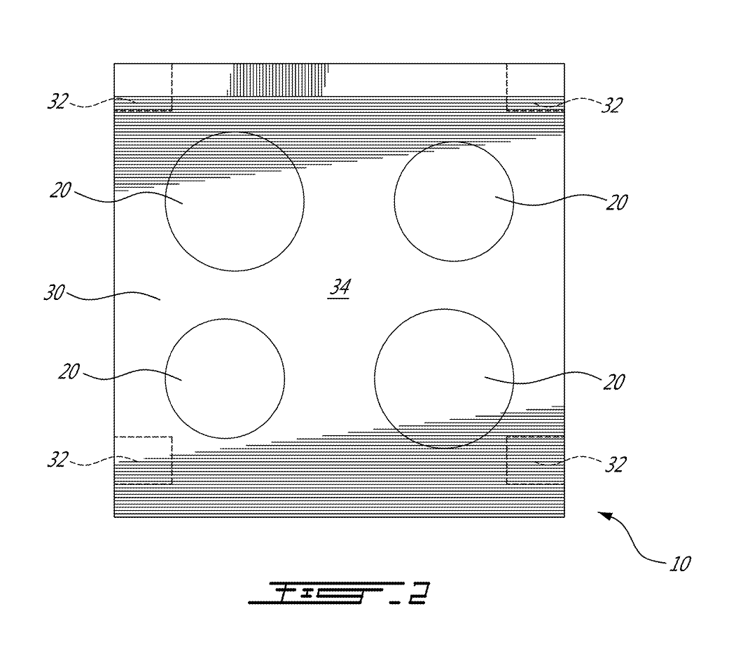

Force sensors 32 are provided in the lower portion 18 of the body 12 where they are horizontally spread around a center of gravity 34 of the device, as shown in FIG. 2. Each force sensor 32 has a maximum mass capacity of 60 kg. As mentioned above, each of the force sensors 32 are located in corresponding support areas (or contact areas, or legs) in the lower portion 18 of the cooking device 10. The force sensors 32 provide to the computer 24 a current signal relative of the force exerted by the body 12 on the support areas, the current signal being associated to a weight or mass. Indeed, the force (or the weight) exerted by the body 12 is proportional to the mass of the body times the gravity of Earth which can be considered equal to about 9.81 m/s². Accordingly, the measured force values can be associated to the mass by a mathematical operation. It can be noted that the drawer 26 has been modified to prevent a load of the drawer 26 to interfere with the force sensors 32, doing so, the main function of the force sensors 32, which is to measure the weight of food disposed on the heating areas 20 of the cooktop 30 and of the oven 22, is protected. With such an embodiment, the drawer can be loaded with any type of material, without affecting the functions of the device presented herein.

In addition to the four force sensors 32, the cooking device incorporates six temperature sensors disposed in the heating areas 20 of the cooktop 30 and of the oven 22, hidden from the user. These temperature sensors are connected to the computer 24 and each of the temperature sensors provides a signal indicative of the temperature of the corresponding heating areas 20 of the cooking appliance 10. Is it understood that the temperature sensors are resistant to the heat in a normal range of use of conventional home cooking appliances.

Furthermore, the cooking appliance 10 can incorporate two fire detectors. Each of the fire detectors is a spectrophotometer able to measure the intensity of electromagnetic (EM) radiation in the infrared range (IR) in a semi-circular radius of 1 meter, e.g. EM waves having wavelengths in the range 700 nm to 1 mm.

Additionally, the cooking appliance 10 has two contact sensors. The first contact sensor is incorporated in the middle portion 16 of the body 12, and more particularly in a region of the door 24 of the oven 22. The first contact sensor is arranged in such a manner that a characteristic signal of an opened door 24 is generated when the door 24 is opened, and a characteristic signal of a closed door 24 is generated when the door 24 is closed. The second contact sensor is incorporated in the lower portion 18 of the body 12, and more particularly in a region of the drawer 26. The second contact sensor is arranged in such a manner that a characteristic signal of a closed drawer is generated when the drawer is closed and a characteristic signal of an opened drawer is generated when the drawer is opened. An example of such a contact sensor could be an electromagnetic contact sensor, where a circuit is in an opened state when there is no contact between two electrodes of the circuit, hence inhibiting propagation of current between the two electrodes. Inversely, the circuit is in a closed state when there is contact between the two electrodes of the circuit, hence enabling propagation of current between the two electrodes.

Relays are also incorporated in the cooking appliance 10. Indeed, these relays enables the computer 24 to have access to functionalities such as cooking modes, a light in the oven 22, an audible sound generator and its level of intensity. Moreover, a relay enabling the control of a power supply enables the computer 24 to disable the power provided to the heating surfaces and the oven 22 in a case of emergency.

The computer 24 may comprise one or more data processors (referred hereinafter as “processor 27”) and one or more associated memories (referred hereinafter as “memory 29”). The computer 24 may comprise one or more digital computer(s) or other data processors and related accessories. The processor 27 may include suitably programmed or programmable logic circuits. The memory 29 may comprise any storage means (e.g. devices) suitable for retrievably storing machine-readable instructions executable by the processor 27. The memory 29 may comprise non-transitory computer readable medium. For example, the memory 29 may include erasable programmable read only memory (EPROM) and/or flash memory. The memory 29 may comprise, for example, but is not limited to, an electronic, magnetic, optical, electromagnetic, infrared, or semiconductor system, apparatus or device. Such machine-readable instructions stored in the memory 29 may cause the processor 27 to execute functions associated with various methods disclosed herein or part(s) thereof. The computer 24 is operatively connectable to external devices (e.g. third party devices) via the Internet using one or more wired connections and/or via one or more wireless connections. Such wired connections can include universal serial bus (USB) connections while wireless connections can include WiFi and Bluetooth™ technologies, only to name a few. Such connectivity can be referred to as the Internet-of-Things which enables the computer 24 of the device 10 to be connected to the external devices for, but not limited to, monitoring and information-sharing purposes. For instance, this connectivity can thus allow the external device to monitor the impaired user via the Internet. The computer 24 can be provided in the form of an electronic tablet or any mobile device having the processor 27, a display 31 and the storage media (or memory 29) operatively connected altogether. The electronic tablet can be a Google Nexus 7 having the operating system (OS) Android 4.1. The OS incorporates a program stored on the memory 29 which allow the user to control the level of heat to be generated by the heating areas 20 of the cooktop 30 and of the oven 22 along with other functionalities generally provided in commercially available cooking appliances. In this embodiment, the display 31 is a touch-screen display 31 where an interface of the program is provided to the user. Using the interface, the cognitively impaired user can select one of the given modes of operation of the program to cook a recipe. The measured force values are provided to the computer 24, where they are analysed in order to determine the state of the activity.

The program usable through the use of the computer 24 (electronic tablet) incorporated in the cooking appliance 10 has two modes of operation: the user mode and the administrator mode.

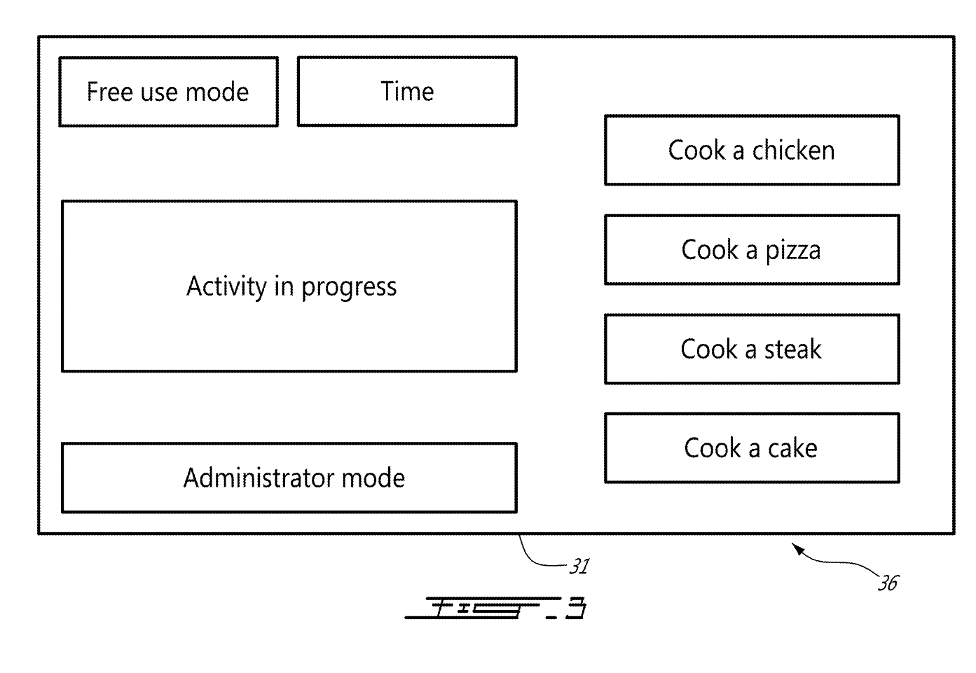

In the user mode, the functions accessible to the cognitively impaired user are limited. The user mode can have an interface of the user mode 36 as the one presented in FIG. 3, the user mode providing two functions: a free use mode and a recipe-monitoring mode. The main window of the user mode has a free use mode button along with choices of recipe to be followed in the recipe-monitoring mode. For instance, these choices of recipe are represented by a “cook a chicken” button, a “cook a pizza” button, a “cook a steak” button and a “cook a cake” button. The main window of the user mode also displays an administrator mode button to access to the administrator mode of the device. Furthermore, the free use mode has a time indicator and few ongoing activities indicators of the cooking appliance 10.

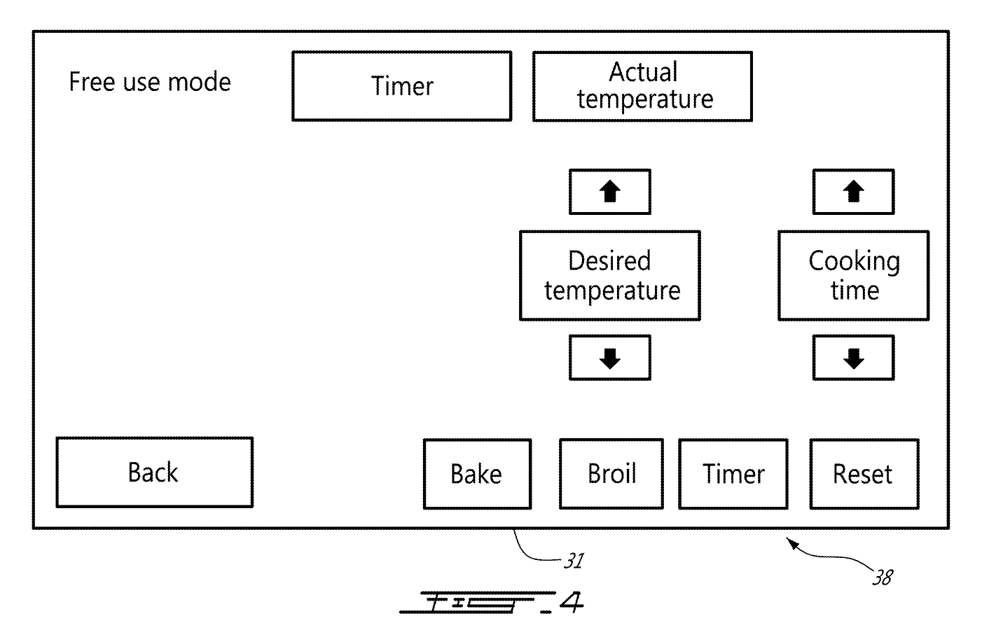

In the free use mode, the software prompts an interface of the free use mode 38, as exemplified in FIG. 4, where basic functions generally provided by commercially available cooking appliances are accessible. Basic functions such as a time indicator, an indicator of actual temperature of the oven 22, a field for a desired temperature of the oven 22, a field for the desired period of cooking time, a bake button, a broil button, a timer button and a reset button. The indicator of actual value of temperature of the oven 22 shows a numeric value of the temperature (in Fahrenheit degrees or in Celsius degrees). The field for the desired value of temperature of the oven 22 is adjustable (with the arrows button) to set the oven 22 at a given value of temperature. The difference between the actual value of temperature and the desired value of temperature is indicative of the remaining time of pre-heating of the oven 22, e.g. the time before the oven 22 reaches the desired temperature. The field for the desired period of cooking is adjustable (with the arrows button) to set the cooking time. The bake button activates the oven 22, for instance, at the desired temperature for the desired period of cooking time. The broil button activates the oven 22 at a relatively high temperature. If the user uses the timer, the remaining time before the time is up is showed in the interface, and when the timer is up, an audible alert is communicated to the user. Also, the reset button set the fields to their default values.

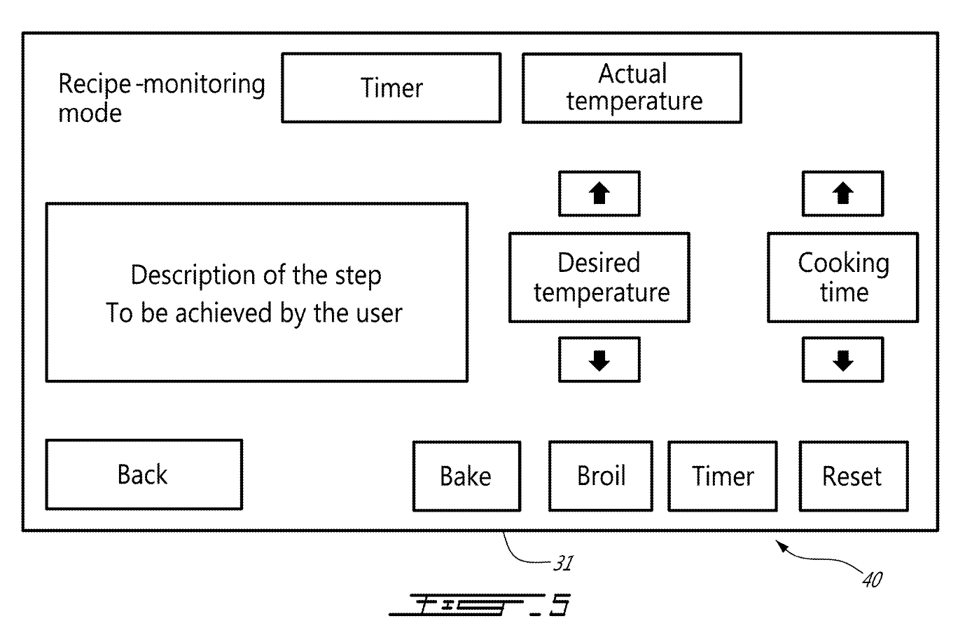

To access the recipe-monitoring mode, the user can select a recipe button in the user mode. Once the user has selected the desired recipe, an interface of the recipe-monitoring mode 40 as shown in FIG. 5 is prompted to the user. For instance, the interface has a “back to the user mode” button, a time indicator, an indicator of the actual temperature of the oven 22, an administrator mode button, fields for the desired temperature of the oven 22 and for the desired cooking time, which both can be tuned using arrows buttons. In addition to the buttons of the free use mode, the recipe-monitoring mode has a chosen recipe indicator and an indicator of the current step to achieve. It can be noted that each step that do not include either cooking the food or heating the product, can be marked as completed using the “step is completed” button. Alternatively, the user can also decide to use the “step is completed button” if he believes that the food is well cooked, even if the period of cooking time is not elapsed. Each of the recipes has steps, which can include cooking or not. For example, the step of taking the chicken out from the freezer and the step of unfreezing the chicken in putting it in water for one hour are steps that do not include cooking. However, the step of heating the chicken at 375 F for 60 minutes needs cooking and can be assisted with the device described herein. The recipe-monitoring mode is adapted to verify the signals from the force sensors 32, from the temperature sensors and from the contact sensors to monitor each of the steps of the recipe, as will be exhaustively detailed below. When all the conditions of a given step are met, the computer 24 provides the following step and its description to the user. When the conditions of a given step are not met, the computer 24 can advise the user in order to help him achieve the step. The conditions can include the temperature of the heating surface or of the oven 22, a period of cooking time, the weight of food, and on which heating area the weight of food is loaded. More particularly, when the force sensor 32 detects a load in the oven 22 in a step where the load should be on one of the heating area 20, the computer prompts an alert to the user, advising him to take the load out of the oven 22 and to place it on one of the heating areas. The conditions can be based on constant values, for instance, when the weight of food is above a threshold value. Alternatively, the conditions can be based on variable values, for instance, the period of cooking time is equal to the measured force value times a certain value. In each of the provided steps, the light of the oven 22, the audible sound generator, the speakers of the electronic tablet and its display 31 can be configured to suitably provided assistance to the user. Of course, the recipe can be updated automatically through an update provided via the OS of the electronic tablet.

Now, the weight of the food contained could be measured and provided to the program in order to correctly adjust the cooking time. For instance, in order to obtain the weight of food, the weight of the food container could be subtracted from the measured load, since the measured load often equals the weight of food added to the weight of the food container. In order to do so, weights associated to one or more food container (vessel, plate, bowl, cauldrons, or the like) could be stored on the memory 29 of the cooking appliance 10, via a registration in the administrator mode. In other words, if the step include a particular amount of chicken to be cooked for a particular amount of time, and that the measured force values indicating a given load could be processed in order to suppress the weight associated with the food container. Then, the processor 27 could adjust the particular amount of time to fit with the measured amount of chicken.

For example, in the case where a cognitively impaired user wants to cook chicken, he would choose the “cook chicken” button. The first step that includes cooking in that recipe could be “preheat the oven at 375 F”. Such a step could be completed only once the user selects the value 375 in the field of desired temperature of the oven, and then the bake button. Once it is done, a next step could be “put the chicken in the oven”. Afterwards, once the user puts the chicken in the oven, the program could calculate a period of cooking time based on the measured weight of the load having the weight of the food contained subtracted therefrom. This step could now be completed once the calculated period of cooking time is elapsed. Of course, the program would advise the user of the completed step after the calculated period of cooking time is elapsed.

Moreover, the cooking appliance 10 described herein can manage erroneous steps of the user. For example, if the step if “preheat the oven at 375 F”, and that the user starts the oven 22 only at 200 F, the cooking appliance 10 could advise the user of that error or even adjust it at the given temperature. The user cannot go to the next step while the oven has not reached the desired temperature. However, if the user decides to put the chicken in the oven before the oven 22 has reached the desired temperature, even if it is a minor error, the program can send an alert to the user advising him that the oven 22 was not at the given temperature. This kind of information provided to the cognitively impaired user can help him to reach more autonomy in the long run. Once the program has recognized that the chicken was put in the oven before the oven has reached 375 F, the program provides the next step, which is “place the chicken in the oven”, but this step has already been done which is measured using the force sensors 32 located in the support areas of the device, henceforth the program sends an alert and passes directly to the next step which is “let the chicken in the oven for a given period of time”, the latter being calculated as a function of the measured weight of food, as described above. During this step, the program could prompt a timer indicator to show the user how many cooking minutes are left. Once the given period of time is elapsed, the program could make an audible sound to advise the user of the completed step. Furthermore, if the user forgets to take the chicken out from the oven after the step is completed, the program could send an alert, or a series of alerts advising the user to turn the oven off or even to take the chicken out from the oven. In the event that after an emergency period of time is reached and that the user has not responded to the advices, the program could shut the power of the oven, hence diminishing a risk of accident and increasing the level of security of the cooking appliance 10.

It is worthy to mention that in the situation presented above, the user chose the “cook chicken” button in order to be assisted by the cooking appliance, perhaps it is only one example of what the cooking appliance can do. Indeed, the user could be assisted by the cooking appliance while cooking a recipe in the free use mode. In that mode, the user is free to perform any cooking activity with the cooking appliance. However, still in the free use mode, the device can detect if a weight of food has been forgotten on one of the heating areas. If the cooking appliance detects such a state of the activity, it could advise the user of a risk and if the user do not react to that advice, it could shut down the power of the heating area in order to reduce the risk of accident associated with a forgotten heating area. Furthermore, the cooking appliance could detect if a proper heating area has been turned on. Indeed, if the device detects that a load has been applied on a back-right heating area and that only a back-left heating area has been turn on, the cooking appliance could assist the user in advising him/her to carefully move the load to the heating area that has been turned on. Inversely, the device could advise the user to turn down the back-left heating area and to turn on the back-right heating area instead, for instance.

To have access to the administrator mode, the user can enter a given username and/or a given password. Once in this mode, the administrator could verify the status of the various sensors, and/or update the program via a network connection, and/or calibrate the force sensors, and/or measure and calibrate a weight of a food container and more, depending on the needs.

While the user is either in the user mode or in the administrator mode, the cooking appliance 10 is programmed to verify three prevention actions. The first prevention action is to monitor the temperature of each of the heating areas 20 of the cooktop 30 and of the oven 22 over time in order to detect if it has not been forgotten. Indeed, if the temperature of one heating area increases, the program detects that a heating area has been activated. Consequently, if the measured force values associated with the activated heating area do not change over time, and that the temperature stays high, the program will determine that the user has forgotten to shut down the heating area, and it will advise the user to shut it down since there is a risk to his/her health. Progressively, the cooking appliance 10 could advise the user by a sound having a low level of intensity, and if it is not sufficient to catch the attention of the user, the level of intensity could increases. Finally, the program could shut the oven 22 itself using the relay of the power supple, to prevent accidents.

The second prevention action is to verify that the door 24 of the oven 22 is closed while the device is in the cooking mode. This is achieved using the contact sensor located in the middle portion 16 of the body 12 of the cooking appliance 10. If the contact sensor detects that the door 24 is opened while in the cooking mode, the program will start to measure a time. After five minutes, the device will emit an audible sound and flash the light of the oven 22. After another five minutes, a tutorial video advising the user of the risk of accident could be displayed on the electronic tablet. After fifteen minutes, if the user has not closed the door 24, the program could shut the oven 22 off once again using the relay of the power supply, also to prevent accidents.

The third prevention action is to verify if there is a fire starting in any one of the heating areas of the cooking appliance 10. Indeed, using the IR EM radiation detectors, the program is adapted to differentiate EM radiation coming from the sun from EM radiation imparted by the heating areas and from EM radiation coming from flames. Once the program has recognized EM radiation coming from flames, it can shut off all the heating areas of the device and can call emergency services through the network (e.g., the Internet) on which the device is connected.

It is important to note that the force sensors located in the support areas of the body 12 can help to determine a load distribution on the device. Indeed, the load distribution of the device evenly lying on a flood, for instance, is relatively evenly distributed. One can calibrate the device while being in the administrator mode. The calibration is easy, in fact, one can suitably unload the device and let the program perform several measurements in order to determine a mean weigh of the body 12 of the cooking appliance 10. Once the calibration is done, any load added to or in the device can be monitored by comparing the measured force values to the force values of the unloaded device. The processor 27 measures the force values at a given frequency (each 200 ms), and averages the last twenty, for instance, measured force values for each of the force sensors. After the device has averaged twenty force values, it fits a Gaussian with the number of averaged values in order to find the center of the Gaussian. This is done to assure that a change in the measured force values be applied on a certain period of time before being recognize as an actual force. The device can also combine the information from the force sensor to the information from the temperature sensor and from the first contact sensor in order to correctly evaluate the state of the activity.

As for an example, let's suppose that the cooking appliance 10 has four force sensor, located at each legs (or support areas) of the cooking appliance 10. In this case, four heating areas 20 are made integral to the cooktop 30 of the cooking appliance 10, vertically aligned with corresponding support areas. Table 1 presents measured force values for four force sensors located at four horizontally, namely the front-right support area, the front-left support area, the back-right support area and the back-left support area. In case 1, the measured force values correspond to the measured force values typically obtained after the calibration described above. In case 2, the device detects a relatively important load at the front-right support area, which is associated to a load on the front-right heating area with a medium level of certainty. From case 2 to case 3, the measured force values are similar. However, the temperature sensor of the front-right heating area detects an increase of temperature. The device now considers that a load is located on the front-right heating area with a strong level of certainty. In case 4, the measured force values of the four force sensors has increased by a similar amount in an evenly distributed manner. Considering that the first contact sensor shows that the door was opened and that the additional load is distributed in an evenly manner, the device considers that the user put a load in the oven with a strong level of certainty. In case 5, the measured force values indicated that a load has been removed from the front-right support area, and still show an evenly distribution load on the four support areas.

TABLE 1
Measured force values for four force sensors located at four
horizontally spaced support areas for different cases

| | Measured force values (arbitrary units) | | | |
|---|---|---|---|---|
| | Front-right | Front-left | Back-right | Back-left |
| | support area | support area | support area | support area |
| Case 1 | 0 | 0 | 0 | 0 |
| Case 2 | 800 | 30 | 25 | 8 |
| Case 3 | 803 | 28 | 27 | 9 |
| Case 4 | 1052 | 277 | 281 | 268 |
| Case 5 | 248 | 251 | 246 | 249 |

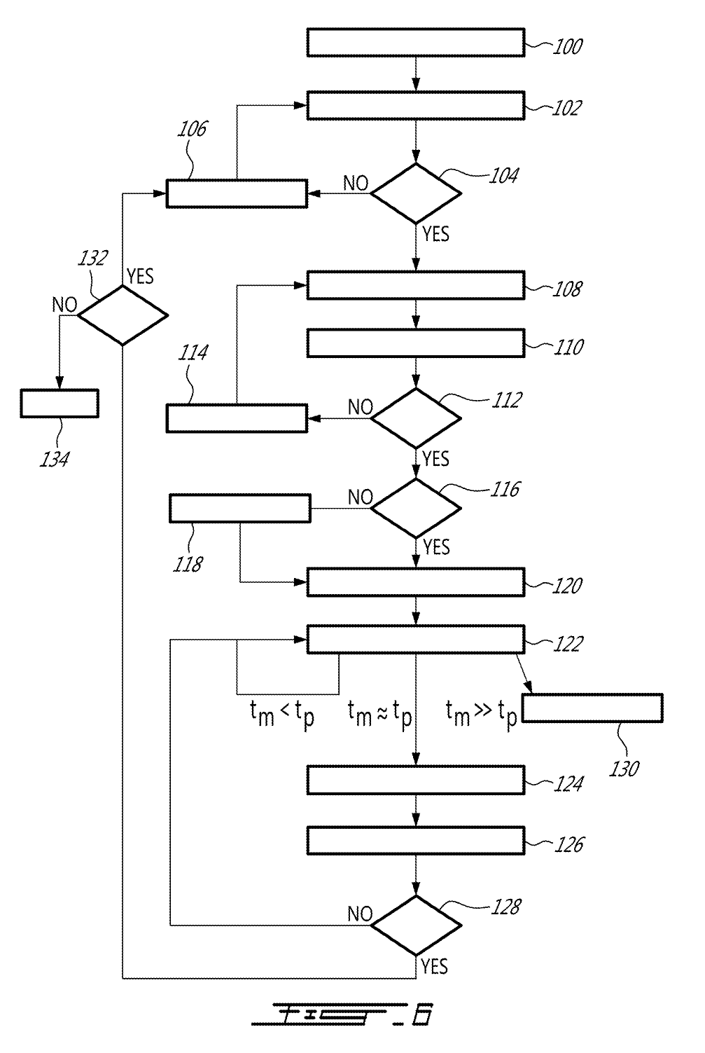

Additionally to the example above, FIG. 6 shows a flow chart of an example of an algorithm that can be used using the cooking appliance 10 described above. Sequentially, the user is asked to choose a recipe at the step “select a recipe” 100. After which, the program provide a given step of the recipe that includes a predetermined heating area and typically a weight of food to be cooked at the step 102. Then, the algorithm verifies if the given step needs cooking the food at step 104. If the answer is negative, the algorithm go to step 106 which is “go to next step” where which it go from a current step to a next step, for instance. The step 106 leads back to step 102 to verify if the next step needs cooking. If the answer is positive, the algorithm goes to step 108 which is “measuring force values and comparing the measured force values with the reference force values provided in step 102”. The program then determines a load distribution in step 110, and verifies if the load distribution indicates that the predetermined heating area is loaded in step 112. If the answer is negative, then maybe an erroneous heating area has been loaded or maybe no heating area has been loaded. In both cases, this is an error in the recipe. In this situation, the program advise the user of the error in step 114 and then goes back to step 108. If the answer is positive, the predetermined heating area has been successfully loaded. Following step 116 verifies if the measured force values correspond to the weight of food advised in step 102. If the answer is negative, the algorithm can adjust (in step 118) the period of the cooking time in order to cook the food adequately and pass to step 120. If the answer is positive, then the right amount of weight of food is loaded on the right heating area and the recipe can goes on to step 120 which measures a time from the beginning of the given step. The following step, which is step 122 compares the measured time (tₘ) to the calculated period of cooking time (tₚ). If tₘ<tₚ, the algorithm does nothing and goes back to step 122. When the measured time reach the calculated period of cooking time tₚ (tₘ≈tₚ), the food is considered to be well cooked and the algorithm goes to step 124 which is “advising the user of a completed step”. The following step 126 is “advising the user of the next step”. Once the next step has been advised to the user, the algorithm verifies if there is any change in the measured force values in step 128. If the answer is negative, the algorithm goes back to step 122 where it compares the measured time tm to the calculated period of cooking time tₚ once again, and so on. In the even where tₘ>>tₚ (by 10 minutes, for example), the algorithm goes to step 130 which is “advising the user of a risk”. In more detailed algorithms, there could be step following step 130 which could shut off the predetermined heating area in order to ensure safety of the user. However, in the event that the user takes the load off the predetermined heating area after step 126, the algorithm goes back to step 106 where a next step is advised to the user. Of course, step 132 verifies if there is any other step in the recipe. If the answer is negative, the recipe is completed and is further advised to the user in step 134.

In this embodiment, the device can be a heating device that has at least one heating area or it can be a smart stove that has heating areas 20 made integral to the body 12, an oven 22 made integral to the body 12 and having at least one heating 20 area therein. The cognitively impaired user can then load the heating areas 20 with a weight of food or product thereby modifying a load distribution of the device during the activity. A computer 24 can be connected to the force sensors (or any of the other sensors mentioned above). Typically, the computer 24 has a processor 27 connected to the force sensors and adapted to determine the load distribution of the loaded body based on the measured force values for a given period of time which can be indicative of a state of an activity performed by the user. The computer 24 has a memory 29 connected to the processor 27 for storing recipes having steps, each of the plurality of steps being associated to reference force values to be exerted by the body 12 loaded at a predetermined heating area. Stored in the memory 29 is a program operated by the processor 27, the program is adapted to sequentially advise the user of the steps of the recipe upon selection by the user. Then the program compares the measured force values associated to the load distribution of the body 12 to the reference force values of each of steps of the recipe; and determines the state of the activity being performed by the user. Later on, the state of the activity can be associated to a given one of the steps of the recipe for a portion of the given period of time. Finally the computer 24 has an interface that can allow the user to interact with the program for a selection of a given one of the at least one recipe. It is readily understood that the smart stove can be used at home for cooking purposes while the heating device can be used either at home or in an industrial environment. Indeed, the heating device could be an industrial oven where a product is dried by transferring a certain amount of heat to it according to a particular recipe performed by an operator. Upon a forgotten step of the recipe or a mistaken step of the recipe, the heating device could assist the operator with its tasks. For instance, the heating device could stop to heat a product if it has been heated for a time exceeding a threshold value of time duration. It is readily understood that in this situation, the cognitive impairment of the operator could be its tiredness or its lack of experience. Consequently, by determining the state of the activity, the heating device could generate a signal in order to advise the operator of a next step, or of a risk depending on the determined state of the activity.

In another embodiment, the device has a body having an upper portion and a lower portion, and a resting area made integral to the upper portion of the body. The resting area can be a seat or a bed that is loadable by a portion a weight of the user. In fact, the user can sit or lay on the resting area. Still in this embodiment, force sensors are provided in support areas located in the lower portion of the body in order to measure force values over a given period of time. The four force sensors, for example, can be horizontally spread around a center of gravity of the device. In fact the measured force values can help to measure a load distribution of the device as a function of time. A memory 29, connected to the force sensors, can store the measured force values over the given period of time. Using the measured force values and the load distribution, one can determine a state of the activity of the user. In this embodiment, the state of the activity can be an excited state, a relaxed state, an ergonomic state, an unsecure state and an empty state. For example, with a device of the instant embodiment, one could study the stored measured force values in order to determine if the user has had an excited night of sleep, a relaxed night of sleep, and even to determine the frequency at which the user is woke up during a night. As another example, with a device of the instant embodiment, one could study the stored measured force values in order to determine if the user is sitting on his chair in a concentrated state (evenly distribution load distribution) or in an excited state (unevenly distributed load distribution), and further determine statistics based on said measured force values. These statistics could help the cognitively impaired user to have a better posture (more ergonomic or secure) either lying on a bed or sitting on a chair.

In another embodiment, a smart chair can have force sensors adapted to measure force values applied by the loaded body to corresponding ones of the plurality of support areas. Each of these force sensors being horizontally spaced from a center of gravity of the device and horizontally spaced from one another. The smart chair can have a seat made integral to the body and loadable by a portion of a weight of the cognitively impaired user sitting thereon. A processor 27 can be provided in order to communicate with the force sensors. The latter can be adapted to determine a load distribution of the loaded body based on the measured force values for a given period of time and to associate a state of an activity to the measured force values. The smart chair can further have a memory 29 in communication with the processor 27 for storing the load distribution of the device based on the measured force values for a portion of the given period of time and wherein the load distribution of the device is indicative of the state of the activity of the user for the at least a portion of the given period of time. The smart chair can also have a program operated by the processor 27 and stored on the memory 29 which is adapted to determine either a posture or a movement of the user based on the load distribution of the device for the at least a portion of the given period of time and an interface (such as a touch screen display 31, or a typical display 31 and control buttons) for allowing the user to interact with the program for at least a selection of a given one of the at least one recipe. In this case, the state of the activity can be a posture such as a relaxed state, an excited state, a concentrated state, or states having an uneven load distribution, such as a bent-forward state, a bent-backward state, a bent-rightward sate and a bent-leftward state, for instance. It can also help determining a movement of the user during the given period of time. Accordingly, the smart chair can determine the frequency at which the state of the activity varies from one state to another. In another embodiment, the smart chair can be integrated in a vehicle for monitoring the activity of the user driving the vehicle. Indeed, the posture of the driver can be monitored in order to determine the state of the driving activity. For instance, it could be determined if the user is in a concentrated state, in a excited state, in a tired state and in a drunk state. It is therefore understood that in this situation, the cognitive impairment of the user could be its tiredness or its drunkenness. Consequently, by determining the state of the driving activity, the smart chair could generate a signal in order to advise the driver or a passenger seating nearby of a risk.

In another embodiment, a smart bed can have force sensors adapted to measure force values applied by the loaded body to corresponding ones of the plurality of support areas. Each of these force sensors being horizontally spaced from a center of gravity of the device and horizontally spaced from one another. The smart bed can also have a bed made integral to the body, which can be loadable by a portion of a weight of the cognitively impaired user lying thereon. The smart bed can incorporate a processor 27 connected to the force sensors and adapted to determine a load distribution of the loaded body based on the measured force values for a given period of time. The load distribution can be associated to a state of an activity performed by the user, which can be stored in a memory 29. The latter being in communication with the processor 27 and adapted to store any signal generated by the force sensors. Typically, the load distribution of the device is indicative of the state of the activity of the user for a portion of the given period of time. For the case of the smart bed, the state of the activity can be a posture such as a relaxed state, an excited state, a concentrated state, or states having an uneven load distribution, such as a bent-forward state, a bent-backward state, a bent-rightward sate and a bent-leftward state, for instance. It can also help determining a movement of the user during the given period of time. Accordingly, the smart bed can determine the frequency at which the state of the activity varies from one state to another. For example, the smart bed could provide statistics on the frequency at which the user wakes up over a night of sleep, on a number of hours of sleep identified as relaxed state compared to a number of hours of sleep identified as an excited state.

The device described herein is used for monitoring an activity of a cognitively impaired user such as an elderly person or a person having intellectual disabilities. The device has a body resting on support areas located in a lower portion of the body of the device. The body of the device has a given weight which exerts forces on the ground. The support areas are generally horizontally spread around a center of gravity of the body, which increases the stability of the device resting on the ground. It is understood that the support areas can be areas of a single larger area incorporating all the support areas. However, the device typically has four support areas horizontally spread around in the lower portion of the body. Furthermore, the device has force sensors located at each of the support areas and the force sensors are adapted to measure the force exerted by the body onto the ground. Additionally, the device is loadable by the user, which means that, during use, the user can either load the device with an object or load the device with a portion or a totality of his weight.

More particularly, the device has force sensors located at the support areas in order to measure force values exerted by the weight of the body onto the ground on which it rests. The measured force values are used to determine a load distribution of the body both at a given time and over a given period of time. For example, if a load is applied on a position spaced from the center of gravity of the body, a first measured force value of a force sensor proximate to the position where the load is applied will be likely higher than a second measured force value from a force sensor distal to the position where the load is applied. Accordingly, the load distribution in this situation will be likely to be unevenly distributed.

The device further has a processor 27, incorporated to the body and in communication with the force sensors. The processor 27 is used to analyse the measured force values in the determination of a state of an activity of the cognitively impaired user. Typically, once the state of the activity is determined, a signal is generated, the latter being displayed on a display or stored on a memory 29, for instance. The stored signals can further be used to determine statistics indicative of the usage of the device by the user.

As can be seen therefore, the examples described above and illustrated are intended to be exemplary only. The method of monitoring an activity of the cognitively impaired user and the device thereof could be applied in a stove, a chair or a bed, for instance. Although presented as constant values, the reference force values and the period of cooking time could be provided as ranges of constant values, depending on the application and on the chosen recipe. The scope is indicated by the appended claims.

What is claimed is:

1. A method for monitoring an activity of a cognitively impaired user using a device having a body resting on a plurality of support areas and loadable by the cognitively impaired user, the method comprising:
measuring a plurality of force values exerted by a weight of a load to corresponding ones of the support areas;
obtaining a state of an activity of the cognitively impaired user based on the measured values; and
generating a signal indicative of the state of the activity.

2. The method of claim 1 further comprising advising the user of a risk to his/her health based on the obtained state of the activity.

3. The method of claim 2, wherein the risk to his/her health is a risk of fire.

4. The method of claim 1, wherein the device has at least one heating area, the load including at least a weight of a product; the method further comprising:
providing a recipe having a plurality of steps, at least a given one of the steps of the recipe including heating the product and including reference force values to be exerted by the load at a predetermined heating area;
determining reaching the given step in the recipe;
during the given step of the recipe, comparing the measured force values to the reference force values; and
obtaining the state of the activity based on said comparing.

5. The method of claim 4, wherein the load further includes a weight of an empty product container.

6. The method of claim 4, wherein said given step of the recipe includes reference force values to be exerted by the weight of the empty product container at the predetermined heating area; wherein said comparing further comprises subtracting the reference force values associated to the empty product container from the measured force values of the load at the predetermined heating area; obtaining force values indicative of the weight of product; and adjusting a given period of time associated to the given step based on said measured values associated to the weight of product.

7. The method of claim 4 further comprising associating the state of the activity to a completion of the given step upon determining that the measured force values correspond to the reference force values, and generating a signal indicative of the completion of the given step.

8. The method of claim 4 further comprising associating the state of the activity to a failure of the step upon determining that the measured force values do not match the reference force values based on said comparing, and advising the user of the failed step.

9. The method of claim 4 further comprising associating the state of the activity to a forgotten step upon determining that the measured force values do not match the reference force values of the given step and matches the reference force values of a step subsequent to a step following the given step of the recipe, and advising the user of the forgotten step.

10. The method of claim 4, wherein said given step of the recipe includes a threshold value of time duration during which the load is be provided at the predetermined heating area, the method further comprising measuring a duration of the elapsed time since a beginning of the given step; comparing the duration of the elapsed time since the beginning of the given step to the threshold value of time duration; and wherein the step of said comparing is performed at least at two different moments during the time duration of the given step.

11. The method of claim 4 further comprising advising the user of an indication on how to correctly achieve the given step when the step has been failed based on said comparing.

12. The method of claim 1, wherein the device has a resting area loadable by at least a portion of a weight of the user, and wherein said measuring a plurality of force values further comprises:
measuring the force values over a given period of time;
storing the signal measured over the given period of time; and
associating at least a portion of the given period of time to the state of the activity.

13. The method of claim 12 further comprising monitoring either a posture or a movement of the user over at least a portion of the given period of time and obtaining the state of the activity based on said monitoring.

14. A device for monitoring an activity of a cognitively impaired user, the device comprising:
a body resting on a plurality of support areas and loadable by the cognitively impaired user; and
at least three force sensors adapted to measure force values applied by the loaded body to corresponding ones of the plurality of support areas, each force sensor being horizontally spaced from a center of gravity of the device and horizontally spaced from one another.

15. The device of claim 14, wherein the device is a heating device comprising:
at least one heating area made integral to the body, wherein at least one of the at least one heating area is loadable with at least a weight of a product thereby modifying a load distribution of the device during the activity;
a computer connected to the sensors, the computer comprising:
a processor connected to the at least three force sensors and adapted to determine the load distribution of the loaded body based on the measured force values for a given period of time and indicative of a state of an activity performed by the user;
a memory connected to the processor for storing at least one recipe, the at least one recipe having a plurality of steps, each of the plurality of steps being associated to reference force values to be exerted by the body loaded at a predetermined heating area;
a program operated by the processor and stored on the memory, the program adapted for sequentially advising the user of the steps of the recipe upon selection by the user; comparing the measured force values associated to the load distribution of the body to the reference force values of each of the plurality of steps of the recipe; and determining the state of the activity being performed by the user, the state of the activity being associated to a given one of the plurality of steps of the recipe for at least a portion of the given period of time; and
an interface for allowing the user to interact with the program for at least a selection of a given one of the at least one recipe.

16. The device of claim 15, wherein the heating device is a smart stove further comprising:
an oven made integral to the body and having at least one heating area therein, each of the at least one heating area being loadable with at least a weight of a product.

17. The device of claim 15 further comprising at least one fire sensor operatively connected to the computer, wherein the computer is adapted to advise the user of a risk of fire based on the obtained state of the activity.

18. The device of claim 14, wherein the device is a smart chair comprising:
a seat made integral to the body and loadable by a portion of a weight of the cognitively impaired user sitting thereon;
a processor connected to the at least three force sensors and adapted to determine a load distribution of the loaded body based on the measured force values for a given period of time and indicative of a state of an activity performed by the user;
a memory in communication with the processor for storing the load distribution of the device based on the measured force values for at least a portion of the given period of time; and
wherein the load distribution of the device is indicative of the state of the activity of the user for the at least a portion of the given period of time.

19. The device of claim 14, wherein the device is a smart bed comprising:
a bed made integral to the body, the bed being loadable by a portion of a weight of the cognitively impaired user lying thereon;
a processor connected to the at least three force sensors and adapted to determine a load distribution of the loaded body based on the measured force values for a given period of time and indicative of a state of an activity performed by the user;
a memory in communication with the processor for storing the load distribution of the device based on the measured force values for at least a portion of the given period of time; and
wherein the load distribution of the device is indicative of the state of the activity of the user for the at least a portion of the given period of time.

20. The device of claim 14 further comprising a computer operatively connectable to the device, the computer incorporating at least the processor, the memory, the program and the interface, the computer being adapted to communicate with the plurality of force sensors and to associate a state of an activity to the measured force values.
